(19) United States
(12) Patent Application Publication
(10) Pub. No.: US 2007/0136231 A1
(43) Pub. Date: Jun. 14, 2007

(54) Method for providing access to information in a network

(75) Inventor: Ranjit Padmanabhan, Saratoga, CA (US)

Correspondence Address: William L. Botjer, PO Box 478, Center Moriches, NY, 11934, US

(73) Assignee: FATLENS INC.

(21) Appl. No.: 11/297,925

(22) Filed: Dec. 9, 2005

(51) Int. Cl. G06F 17/30

(52) U.S. Cl. 707/2

(57) ABSTRACT

A method, system and computer program product for accessing information from a dataset in a network is provided. An example of the dataset may include a webpage, which has a pre-defined context associated with it. A dictionary is selected, corresponding to the pre-defined context. Context-relevant information is identified from the content of the webpage, based on the dictionary. At least one link is integrated in the content, based on the context-relevant information. The links on the webpage may invoke one or more pop-ups. The content of the one or more pop-ups is generated in real time and is relevant to the pre-defined context of the webpage.

### BACKGROUND OF THE INVENTION

The present invention relates to a method for generating hyperlinks on a webpage. More specifically, the present invention describes a method for providing access to information in a network for online shopping.

As the Internet has grown in popularity, it has provided users with an additional way of shopping. Users have the option of shopping for products and services that are available over the Internet. With this growing trend, the number of e-commerce transactions is also growing day by day. Examples of transactions include Internet shopping, business-to-business commerce, electronic data interchange, Internet-based business process functions, or any other Internet-based business, economic or financial transactions. These transactions encourage merchants to do more business over the Internet.

Merchants offer their products and services to users through various websites. Users may search for these products on different search engines such as Google® and Yahoo®. Due to increasing competition, different merchants are using different ways to market their products on the Internet. Marketing a product may include advertising it by publishing banners and purchasing keywords on the search engines. However, additional costs are incurred on the purchasing and maintaining of the keywords. Further, publishing banners may modify the content of the webpage structurally.

These additional costs may be reduced by increasing the rank of the webpage in the search results of the queries fired on the search engine. One way of increasing the rank is by including META tags in the code of the webpage. The ranking and placement of the webpage is decided on the basis of the keywords in the META tags. Another way of improving the ranking is by including static pages on the website. Usually, websites generate ‘dynamic’ pages, and their Uniform Resource Locators (URLs), i.e., pages and page links, are generated ‘on the fly’. It is difficult for search engines to locate these dynamic pages and their URLs.

However, the methods described above do not always provide relevant results to users performing a keyword search. This is because these methodologies do not recognize the context in which a particular (searched) keyword has appeared. Further, the increased traffic to the webpage is linearly related to the cost involved in marketing the product. As a result, the cost increases with the increased traffic.

In light of the above discussion, there is a need for a method for providing relevant information to the user. Further, the method should increase the traffic to the webpage, without structurally modifying the content of the webpage, and reduce the cost of marketing a product on the Internet.

### SUMMARY OF THE INVENTION

An object of the present invention is to provide context-sensitive links on a webpage.

Another object of the present invention is to market the product on the Internet without structurally modifying the content of the webpage.

Still another object of the present invention is to increase the traffic towards a webpage.

Yet another object of the present invention is to substantially reduce the cost of marketing on the Internet.

To achieve the objectives mentioned above, the present invention provides a method, system and computer program product for providing relevant information from a dataset in a network. A publisher publishes the dataset by means of the network. The publisher may be a human or a computer process. The dataset has a pre-defined context associated with it. The pre-defined context is any field, related to which information is provided on the dataset. The pre-defined context may include rock concerts, baseball matches, stock trading etc. A dictionary is selected by the publisher, based on the pre-defined context. The dictionary includes information related to the pre-defined context where the information is updated in real-time. For example, the dictionary may include information on tickets being available for rock concerts, the merchants available, and the like. If a ticket for a rock concert is cancelled, this information will be updated in the dictionary. Context-relevant information such as words or phrases is identified from the content of the dataset, based on the dictionary. At least one link is integrated with the content of the dataset, based on the context-relevant information. The links may invoke one or more pop-ups. The content of these pop-ups is relevant to the pre-defined context and is generated in real time. For example, the content may provide information about different merchants selling a product desired by a user. In one embodiment of the present invention, the display attributes of the links and the content of the pop-ups may be modified, based on the preferences of a publisher.

The present invention provides context-sensitive links on a webpage. However, the links do not modify the content of the webpage structurally. Further, they help in tracking events on the webpage. Moreover, the method increases the rank of a webpage on different search engines, and also reduces the cost of marketing a product on the Internet.

The present invention may be used by a company that provides online marketing services to merchants. The merchants may use this invention to market their product over the internet. Further, the invention may help publishers to provide context relative information to their users.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the present invention may be practiced;

FIG. 2 is a block diagram of a system for accessing information, in accordance with an exemplary embodiment of the present invention;

FIG. 3 is a flowchart of a method for accessing information, in accordance with an exemplary embodiment of the present invention;

FIG. 4 is a flowchart of a method for accessing relevant information, in accordance with another exemplary embodiment of the present invention;

FIG. 5 is a webpage illustrating integrated links, in accordance with an exemplary embodiment of the present invention; and

FIG. 6 is a pop-up, in accordance with an exemplary embodiment of the present invention.

### DESCRIPTION OF VARIOUS EMBODIMENTS

The present invention describes a method and system for accessing relevant information from a dataset, and more specifically, for accessing relevant product-related information from the dataset. The dataset has a pre-defined context associated with it. For example, a dataset such as webpage may provide information on methods of stock trading, a music review of a rock album, a review of a baseball match, the history of football, an article on wrestling, ranking of tennis players, and the like. The pre-defined context may include stock trading, rock concerts, baseball matches, football matches, and the like. Context-relevant information is identified on the dataset, based on a dictionary. The dictionary includes product information such as stock prices, tickets available for rock concerts and baseball matches, upcoming football matches, and the like. The dictionary stores the information in a structural manner such as a tree structure. At least one link is integrated with the content of the dataset, based on the context-relevant information. Different events on the links may invoke one or more pop-ups. A pop-up is a web content that appears in a new window with respect to the active window. The pop-up may be a webpage, an applet, a dialog box, a text document, and the like. The content of these pop-ups is generated in real time, based on the dictionary, and provides relevant information about the products related to the pre-defined context.

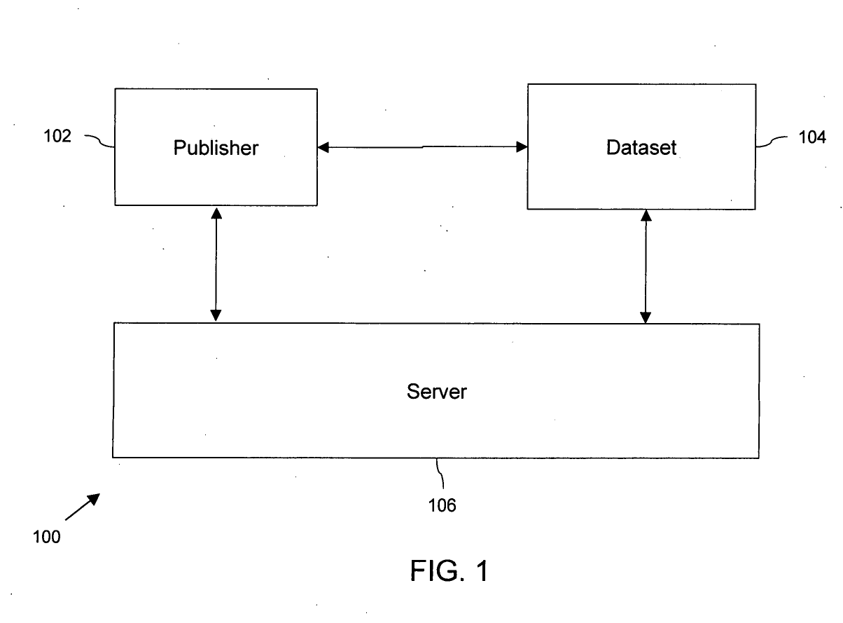

FIG. 1 illustrates an environment 100 in which various embodiments of the present invention may be practiced. Environment 100 includes a publisher 102, a dataset 104, and a server 106. Publisher 102 publishes dataset 104 by means of a network. For example, a webpage may be published by publisher 102 on the Internet. In an embodiment of the present invention, publisher 102 may be a human or a computer process. Dataset 104 is a document used for representing data over the network. Examples of the document may include a webpage, a text document, and any other such source of information. Dataset 104 has a pre-defined context associated with it. The pre-defined context is any field related to which information is provided on dataset 104. Various embodiments of the present invention will, hereinafter, be explained with reference to a webpage. Dataset 104 will hereinafter be referred to as webpage 104. It will be apparent to a person ordinarily skilled in the art that the invention is not restricted to a webpage. Publisher 102 registers the pre-defined context of webpage 104 with server 106, which includes information related to the pre-defined context in the form of one or more dictionaries. The pre-defined context is any field, related to which information is provided on webpage 104. For example, if webpage 104 relates to shoes, the pre-defined context may include products related to shoes, and the dictionary may provide information on various shoe merchants; shoe models, their prices, availability, etc. In one embodiment of the invention, the information on server 106 may be categorized in the form of one or more dictionaries. The dictionaries are structured in a hierarchical manner, i.e., the information is organized in a hierarchical manner. The dictionaries may include information related to the pre-defined context where the information is updated in real time.

In various embodiments of the present invention, network 100 may be a wired or wireless network. Examples of network 100 include, but are not limited to, a Local Area Network (LAN), a Metropolitan Area Network (MAN), a Wide Area Network (WAN), and the Internet. Examples of server 106 may include various search engines such as Google®, Yahoo® and Fatlens®.

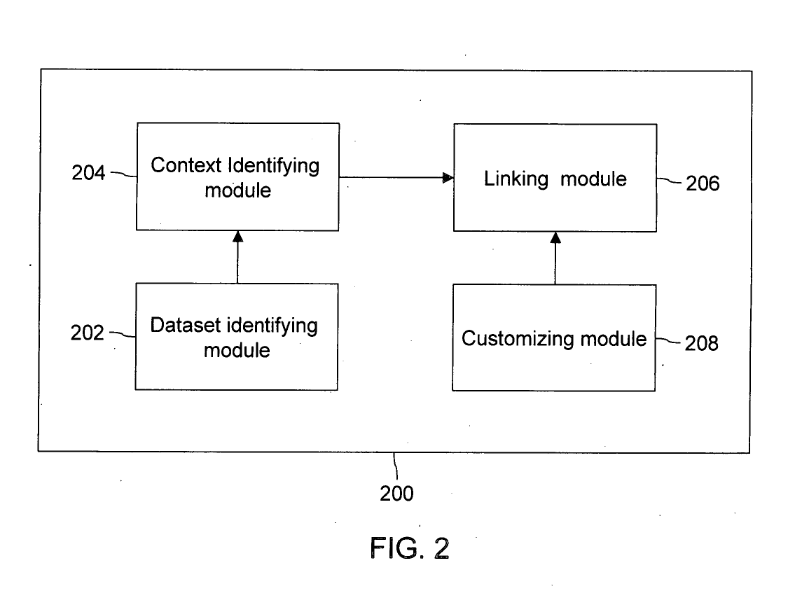

FIG. 2 is a block diagram of a system 200 for accessing information, in accordance with an exemplary embodiment of the present invention. System 200 includes a dataset identifying module 202, a context identifying module 204, a linking module 206, and a customizing module 208.

Publisher 102 registers the pre-defined context associated with webpage 104 with server 106 while publishing webpage 104 on the network. On being registered, dataset identifying module 202 assigns an identification number to webpage 104. The identification number of each webpage is unique and is used to track different events on webpage 104 over a period of time. For example, the events may include the number of ‘clicks’ on the links and the content retrieved from webpage 104. Context identifying module 204 identifies context-relevant information from the content of webpage 104. Linking module 206 integrates at least one link on webpage 104, based on the context-relevant information. For example, hyperlinks may be created on the context-relevant information present on webpage 104. In an embodiment of the present invention, customizing module 208 may customize links on webpage 104, based on one or more preferences provided by publisher 102. In various embodiments of the present invention, customization may include addition, deletion and modification of the links.

In various embodiments of the present invention, dataset identifying module 202, context identifying module 204, linking module 206, and customizing module 208 may be present on server 106 or on an electronic device from where a user is accessing webpage 104. Examples of the electronic device may include a computer, a mobile phone, a Personal Digital Assistant (PDA), and the like. In various embodiments of the present invention, different elements of system 200, such as dataset identifying module 202, context identifying module 204, linking module 206 and customizing module 208, may be implemented as a hardware module, a software module, firmware, or their combination thereof.

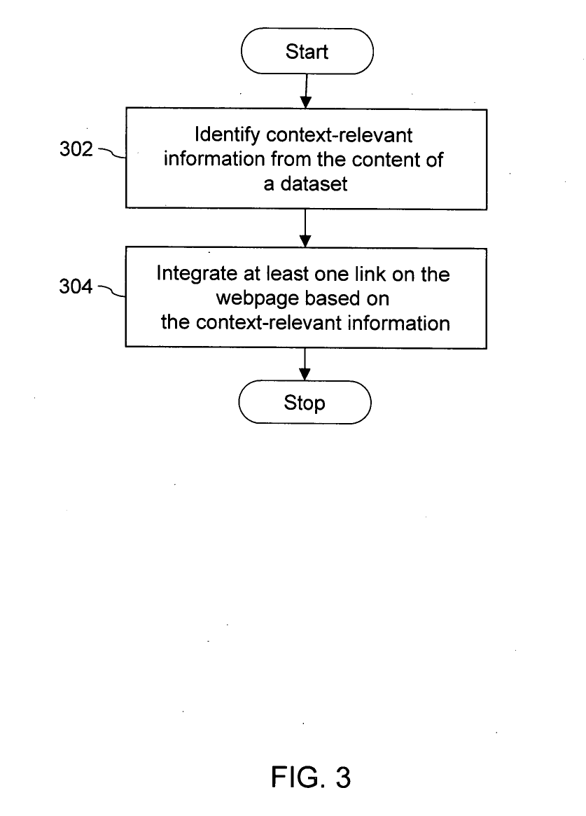

FIG. 3 is a flowchart of a method for accessing information in a network, in accordance with an exemplary embodiment of the present invention. At step 302, context relevant information is identified from the content of a dataset. The dataset has a pre-defined context associated with it. The context relevant information is based on a dictionary. At step 304, at least one link is integrated into the content of the dataset, based on the context-relevant information. The links invoke one or more pop-ups. In various embodiments of the invention, a pop-up may be a window, an applet, a text document and the like. The content of these pop-ups is generated in real time, based on the dictionary, since the dictionary is updated in real time. This content of the pop-up is relevant to the pre-defined context of the webpage. As a result, a user may access relevant information, i.e., the content of the pop-ups, from the dataset. In one embodiment of the present invention, the pop-up may contain links to server 106, which, in turn, provides relevant information.

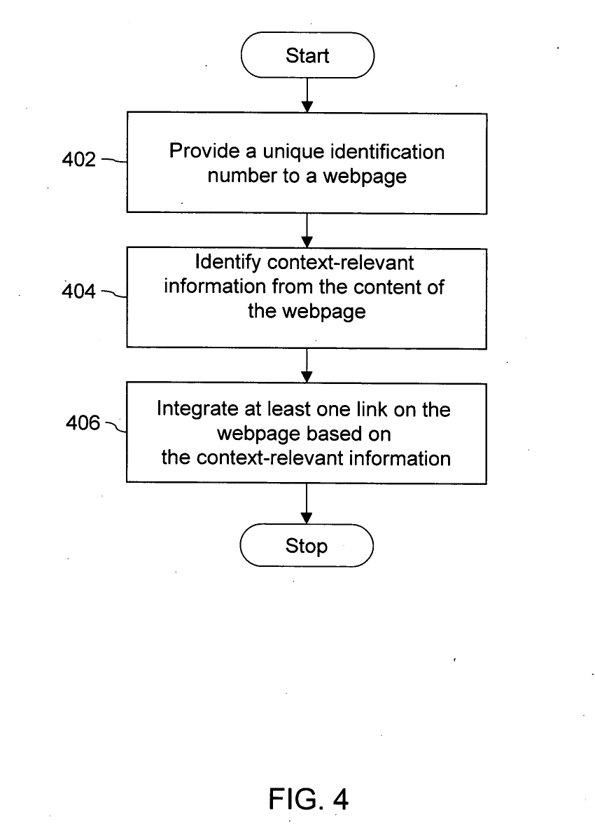

FIG. 4 is a flowchart illustrating a method for accessing relevant information in a network, in accordance with another exemplary embodiment of the present invention. At step 402, an identification number is assigned to a webpage. The identification number is unique for the webpage and is used to track the events on the webpage. The identification number may be assigned by modifying the code of the webpage. In an embodiment of the present invention, the webpage may be modified by inserting one or more instructions in the code of the webpage. In various embodiments of the present invention, the one or more instructions may be a Hyper Text Markup Language (HTML), an Extensible Hypertext Markup Language (XHTML), Dynamic Hypertext Markup Language (DHTML), Cascading Style Sheets (CSS), JavaScript, Java Server Pages (JSP), a Common Gateway Interface Script (CGI), a Hypertext Pre-processor (PHP), and a Visual Basic Script (VB Script), or their combination thereof. The webpage has a pre-defined context associated with it. For example, if the webpage is related to a music review, the pre-defined context may be music shows and concerts.

At step 404, the one or more instructions help in identifying context-relevant information in the content of the webpage, based on a dictionary. The dictionary present on a server stores the information related to the pre-defined context in a structural manner. The structural arrangement defines relationships between attributes corresponding to the pre-defined context. For example, if a rock concert is defined as the pre-defined context, the attributes may include various artists performing in rock concerts, information pertaining to availability of tickets, the merchants offering the tickets, the dates and venues of the shows, and other details about the rock concert. In one embodiment of the present invention, the dictionary is updated in real time with the information related to the pre-defined context. For example, if the date of a rock concert has expired, the rock concert may not be included in the dictionary. Thereafter, at step 406, at least one link is integrated on the webpage, based on the context-relevant information. The links are context-sensitive and hence do not structurally modify the webpage. Further, in one embodiment of the present invention, a link may be a stylized hyperlink.

The links invoke one or more pop-ups. A pop-up is a web content that invokes in a new window with respect to the active window. The pop-up may be a webpage, an applet, a dialog box, a text document, and the like. These pop-ups may be invoked by different events such as a ‘mouse over’, a ‘mouse click’, and a ‘key board click’ performed on the links. The one or more pop-ups also include one or more links to one or more pages relevant to the pre-defined context. The one or more pages may be present on the server.

In an embodiment of the present invention, a publisher may customize each link with one or more preferences, which may include adding, deleting and modifying the links from the webpage. For example, a publisher may specify that only the first occurrence of a particular word in the webpage should be highlighted. Further, the number of clicks on each link, the content retrieved from the webpage, and the page loads may be tracked on the basis of their identification numbers. Moreover, a publisher may define the arrangement of the one or more links present on the one or more pop-ups.

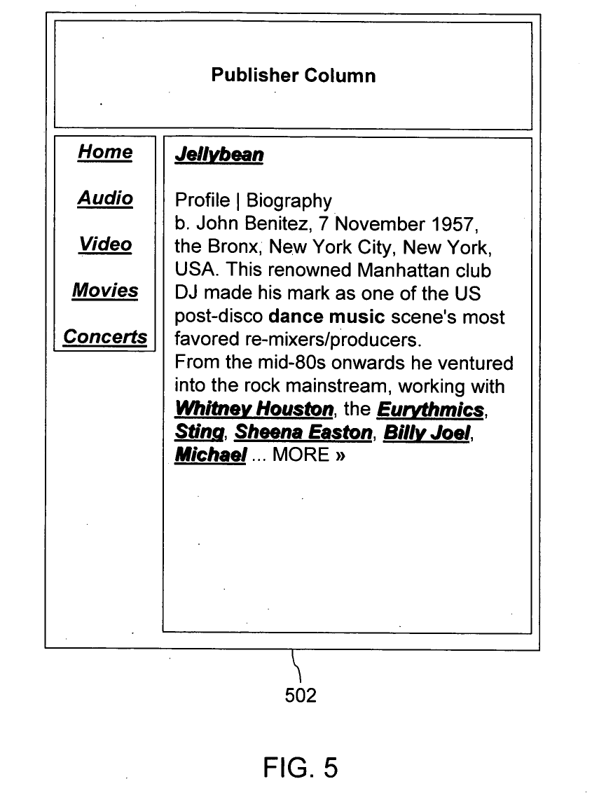

In an embodiment of the present invention, the content of the pop-up may also be modified by the publisher. For example, the publisher may decide whether the content of the pop-up should include commercial information pertaining to merchants or one or more informational links. The method described above is explained in detail in conjunction with FIG. 5.

In an embodiment of the present invention, one or more plug-ins may be provided to a publisher. The one or more plug-ins enhances the editorial capabilities of the publisher. Examples of plug-ins may include, but are not limited to, browser helpers, toolbars, Active-X controls, and the like. In another embodiment of the present invention, the plug-ins may be integrated with various tools, such as Really Simple Syndication (RSS) Readers and Blog Editors.

FIG. 5 is a webpage 502 illustrating integrated links, in accordance with an exemplary embodiment of the present invention. Publisher 102 publishes webpage 502 on the Internet. Webpage 502 provides a short biography of the performer “Jellybean”. Therefore, a pre-defined context associated with webpage 502 may include pop music. Publisher 102 registers the pre-defined context of webpage 502 with server 106. Server 106 assigns an identification number to webpage 502. Further, one or more instructions provided by server 106 are included in the code of webpage 502 by publisher 102. One or more instructions included in the code of webpage 502, when executed, retrieve a rock music dictionary from server 106. The rock dictionary includes one or more words and phrases related to rock music and concerts.

Context identifying module 204 identifies context-relevant information on webpage 502, based on the one or more words and phrases. For example, as shown in FIG. 5, the context-relevant information may include words such as Jellybean, Video, Music, Concerts, Whitney Houston, Eurythmics, Sting, Sheena Easton, Billy Joel, and Michael. These words or phrases relate to rock music. Publisher 102 may select one or more words or phrases from the context-relevant information on which he prefers to put a link. Linking module 206 integrates at least one link on the one or more words or phrases on webpage 502. For example, as shown in FIG. 5, links are integrated on words such as Whitney Houston, Eurythmics, Sting, Sheena Easton, Billy Joel, and Michael. In an embodiment of the present invention, the at least one link may be customized according to the preferences of publisher 102. Examples of customization may include the style, display characteristics such as links with a thick or double line, and other editorial controls related to the links. This customization differentiates the one or more links such as Whitney Houston and Eurythmics from other static hyperlinks such as Home and Audio. Further, publisher 102 may set different preferences for each link. If webpage 502 is a dynamic webpage, publisher 102 may preview the at least one link with these preferences. Thereafter, these preferences may be applied to all the webpages related to the rock concert dictionary.

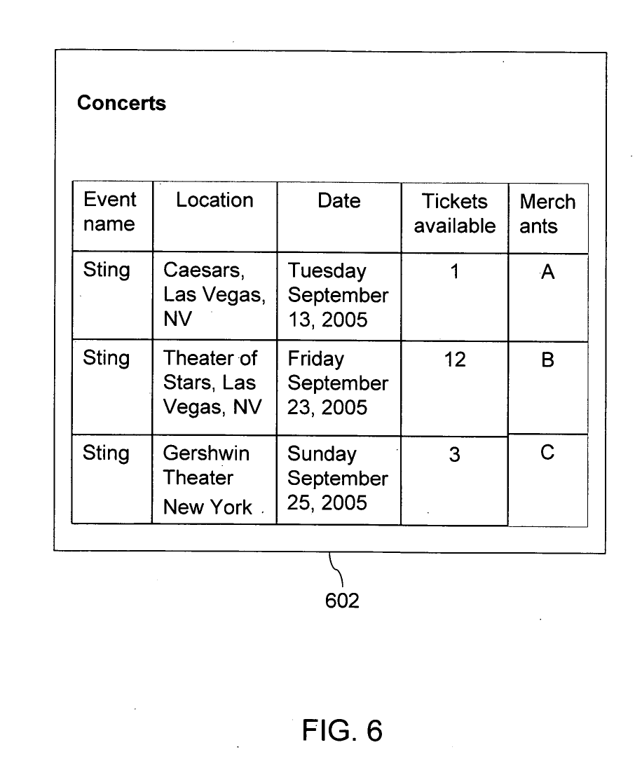

On the click of a mouse, each link on webpage 502 invokes one or more pop-ups. These pop-ups also include one or more links. Further, clicking on the links may redirect a user to one or more webpages available on server 106. The one or more webpages may include information on upcoming rock shows, the tickets available, recommended merchants for them, and the like. In one embodiment of the present invention, publisher 102 may customize the content of the one or more pop-ups. Examples of customization may include the arrangement of the one or more links, the availability of merchant information on the links, and the like. The arrangement of the links is decided on the basis of a predefined condition. An example of the predefined condition may include bidding by merchants. A link (information) provided by a higher bidding merchant is placed at a higher rank. Further, the content of the one or more pop-ups is generated in real time through a call to server 106. The one or more pop-ups are explained in detail in conjunction with FIG. 6.

In one embodiment of the present invention, an identification number is provided to webpage 502. This identification number is used to track events on webpage 502. Examples of these events may include clicks on the links, page loads, content retrieved from webpage 502, and loading of webpage 502 on the Internet.

FIG. 6 is a pop-up 602, in accordance with an exemplary embodiment of the present invention. Pop-up 602 is invoked by an event performed on the link, such as ‘Sting’, as shown in FIG. 5. Examples of events may include a mouse click, a mouse over, a keyboard button click, and the like. Pop-up 602 provides information on the tickets available for Sting concerts. Further, it also provides information about the merchants. In an embodiment of the present invention, pop-up 602 includes information about one or more merchants, based on preferences of publisher 102. For example, merchant B is selling 12 tickets for a Sting concert on Friday Sep. 23, 2005 at Caesars, Las Vegas. In an embodiment of the present invention, incentives such as commission may be provided to publisher 102, to include information pertaining to merchants. These merchants may bid for a higher position on pop-up 602. The decision relating to the arrangement of merchants on pop-up 602 may be computed on server 106. Further, the position of the merchants may be rotated, based on the bidding of the merchants. In an embodiment of the present invention, if information from a new merchant D is included in the rock music dictionary, pop-up 602, invoked thereafter, may include information from the new merchant D, i.e., the content of pop-up 602 is generated in real time. In another embodiment of the present invention, if tickets from a merchant are not available, information about the merchant is not included in the content of pop-up 602.

Further, as the ranking of a webpage on a search engine may be decided, based on the number of links pointing to the webpage, an increase in the number of links integrated by using this method increases the number of links pointing to the one or more webpages on server 106. As a result, ranking the one or more webpages increases on the search engines, this, in turn, increases the traffic to the webpage

The method and system described above have a number of advantages. The method determines information available in a network that is relevant to a pre-defined context of a dataset. It also determines an economical way of marketing products and services in the network. Further, it improves the ranking of a webpage on different search engines such as Google® and Yahoo® and provides the publisher with editorial control over the links. It also provides the publisher with control on the arrangement of the content of one or more pop-ups, which are generated in real time. Moreover, the method may track the number of clicks on the links and the content retrieved from the webpage.

The system for accessing information in a network, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for providing access to information in a network, the method comprising the steps of:
a. identifying context-relevant information from a dataset based on a dictionary, the dictionary including real-time information relating to the context-relevant information of the dataset; and
b. integrating at least one link on the content of the dataset based on the context-relevant information, wherein the at least one link invoke one or more pop-ups, the content of the one or more pop-up providing access to relevant information, the content being based on the dictionary.

2. The method according to claim 1 further comprising the step of assigning an identification number to the dataset.

3. The method according to claim 2 further comprising the step of tracking the dataset based on the identification number.

4. The method according to claim 1 further comprising the step of customizing the at least one link based on one or more preferences of a publisher of the dataset.

5. The method according to claim 1 wherein content of the one or more pop-ups comprises one or more links to the information.

6. The method according to claim 5 further comprising the step of arranging the one or more links based on a predefined condition.

7. The method according to claim 1 wherein the at least one link is a hyperlink.

8. The method according to claim 1 wherein the dataset is at least one of a webpage, and a text document.

9. A system for providing access to information in a network, the system comprising:
a. a context identifying module, the context identifying module identifying context-relevant information from a dataset based on a dictionary, the dictionary including real-time information relating to the context-relevant information of the dataset;
b. a linking module, the linking module integrating at least one link on the dataset based on the context-relevant information, wherein the at least one link invoke one or more pop-ups, the content of the one or more pop-up providing access to relevant information, the content being based on the dictionary.

10. The system according to claim 9 further comprising a dataset identifying module, the dataset identifying module assigning an identification number to the dataset.

11. The system according to claim 10 wherein the dataset is tracked based on the identification number.

12. The system according to claim 9 further comprising a customizing module, the customizing module customizing the at least one link based on one or more preferences of a publisher of the dataset.

13. The system according to claim 9 wherein the content of the one or more pop-ups comprises one or more links to the information.

14. The system according to claim 9 wherein the dataset is at least one of a webpage and a text document.

15. A computer program product for use with a computer, the computer program product comprising a computer usable medium having a computer readable program code embodied therein for providing access to information in a network, the computer readable program code performing the steps of:
a. identifying context-relevant information from a dataset based on a dictionary, the dictionary including real-time information relating to the context-relevant information of the dataset; and
b. integrating at least one link on the dataset based on the context-relevant information, wherein the at least one link invoke one or more pop-ups, content of the one or more pop-up providing access to relevant information, the content being based on the dictionary.

16. The computer program product according to claim 13 wherein the computer readable program code further performing the step of assigning an identification number to the dataset.

17. The computer program product according to claim 13 wherein the computer readable program code further performing the step of tracking the dataset based on an identification number.

18. The computer program product according to claim 13 wherein the computer readable program code further performing the step of customizing the at least one link based on one or more preferences of a publisher of the dataset.

19. The computer program product according to claim 13 wherein the content of the one or more pop-ups comprises one or more links to the information.

20. The computer program product according to claim 17 wherein the computer readable program code further performing the step of arranging the one or more links based on a predefined condition.
